(19) United States
(12) Patent Application Publication
(10) Pub. No.: US 2011/0207569 A1
(43) Pub. Date: Aug. 25, 2011

(54) TOOTHED CHAIN

(75) Inventor: Horst ADEL, GRAEFENSTEINBERG (DE)

(73) Assignee: SCHAEFFLER TECHNOLOGIES GMBH & CO. KG

(21) Appl. No.: 13/031,657

(22) Filed: Feb. 22, 2011

Related U.S. Application Data
(60) Provisional application No. 61/307,003, filed on Feb. 23, 2010.

(51) Int. Cl. F16G 13/06

(52) U.S. Cl. 474/206

(57) ABSTRACT

The toothed chain employs tracks of inner plates, a track of middle plates and tracks of outer plates. At least one track of inner plates or the track of middle plates has teeth projecting in both a first direction and a second direction and a pair of pin holes. The teeth are mirrored along a centerline of each link plate. The outer plates also contain pin holes, and can have a symmetrical shape such that the lower portion and the upper portion have the same shape. The outer plates are fixed to the two tracks of inner plates and track of middle plates by pins that are fitted into the pin holes of the plates, forming an endless loop.

### FIELD OF INVENTION

The present invention relates to control assemblies of internal combustion engines and more particularly to toothed chains for driving an internal component or a balancing shaft.

### BACKGROUND OF THE INVENTION

Toothed chains for control assemblies are typically used in an internal combustion engine for driving internal components and/or balancing a shaft.

Tooth chains, which incorporate tracks of inner plates, a track of middle plates, and tracks of outer plates, are currently designed with dual toothed profiles on both the tracks of inner plates and the track of middle plates. Thus, teeth project in both a first direction and a second direction on the tracks of inner plates and the track of middle plates on existing toothed chains. Due to the current dual profile design on both the inner plates and the middle plates, a significant material cost and production expenditure exists, and the overall weight of the chain is excessive as well.

### SUMMARY OF THE INVENTION

The present invention is directed to a toothed chain that has two tracks of inner plates, a track of middle plates, and two tracks of outer plates. In one configuration, the plates of one of the tracks of inner plates have dual profiles where teeth project from each plate in both a first and a second direction. However, the plates of the other track of inner plates and the plates of the track of middle plates do not have a dual toothed profile design. Instead, the plates of the other track of inner plates and the plates of the track of middle plates have a standard profile design, where teeth only project from each plate in one direction and the other side of each plate has a flat profile. Two pin holes are located in each of the inner plates and the middle plates. Additionally, outer plates contain pin holes and preferably have a symmetrical shape. However, the outer plates can be of a nonsymmetrical shape as well. The outer plates are fixed to the two tracks of inner plates and the track of middle plates by pins that are fitted into the pin holes of the plates, forming an endless loop. By not requiring all tracks of plates to have a dual profile design, less material is required and production costs are lower.

In another configuration, only the plates of the track of middle plates have dual profiles. The plates of both the inner tracks have a standard profile design.

In yet another configuration, the plates of both tracks of inner plates have dual profiles. The plates of the middle track have a standard profile design.

Broadly, the present invention can be defined as a toothed chain that comprises a plurality of middle plates that form a track where each middle plate has a pair of pin holes, a plurality of inner that form two tracks where each inner plate has a pair of pin holes, a plurality of outer plates that form two tracks, each outer plate has a pair of pin holes; and pins that extend through corresponding pin holes of the outer plates. The inner plates and the middle plates fasten the tracks of outer plates, the tracks of inner plates, and the track of middle plates to each other, forming a toothed chain having an endless loop.

In another embodiment, the middle plates of the toothed chain have double-sided profiles.

In yet another embodiment, the inner plates forming one of the tracks of inner plates have double-sided profiles.

In a further embodiment, the inner plates forming both tracks of inner plates have double-sided profiles.

In another embodiment, the outer plates arc symmetrical, such that a lower portion, projecting in a first direction, is mirrored by an upper portion, projecting in a second direction.

Yet another embodiment discloses a tooth height of a gear wheel contacting the toothed chain, which is reduced to provide easier tooth entry on a backside of the toothed chain. In this embodiment, the gear wheel is a component of a water pump and it is driven by a backside of the toothed chain.

### BRIEF DESCRIPTION OF THE DRAWINGS

The present invention will be further understood and appreciated by reading the following description in conjunction with the accompanying drawings, in which:

FIG. 1 is a side view illustrating an assembly of the toothed chain;

FIG. 2 is a top view illustrating a toothed chain having only double-sided plates; and

FIG. 3 is a schematic of a water pump driven by the toothed chain backside.

### DETAILED DESCRIPTION OF THE INVENTION

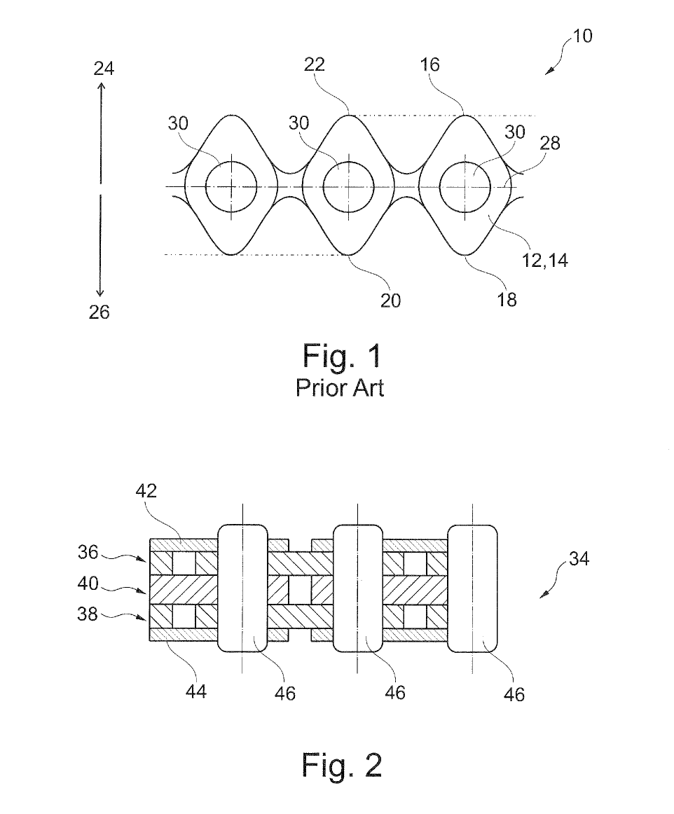

Referring now to the drawings, in which like reference numerals refer to like reference parts throughout, FIG. 1 shows a side view of an existing double-sided chain 10 where each inner plate 12 and each middle plate 14 has a dual profile. The teeth 16, 18, 20, 22 of each inner plate 12 and each middle plate 14 project in a first direction 24 and a second direction 26. The teeth 16, 18, 20, 22 that project in the first direction 24 and the second direction 26, mirror each other along a centerline 28. Additionally, pin holes 30 are located along the center line 32.

FIG. 2 shows a top view of a toothed chain assembly 34. The assembly includes two tracks of inner plates 36, 38, a track of middle plates 40 located between the tracks of inner plates 36, 38 and tracks of outer plates 42, 44 located outside each track of inner plates 36, 38. Each inner plate 36, 38, middle plate 40 and outer plate 42, 44 contains a pair of pin holes 30 (see, FIG. 2). Pins 46 are inserted into pin holes 30 of corresponding outer plates 42, 44, inner plates 36, 38 and middle plate 40, forming the toothed chain assembly 34. Pursuant to the invention, one of the tracks of the inner plates 36, 38 or the middle plate 40 has double-sided toothed profile with teeth 16, 18, 20, 22 projecting in the first direction 24 and the second direction 26, mirroring each other along a centerline 28.

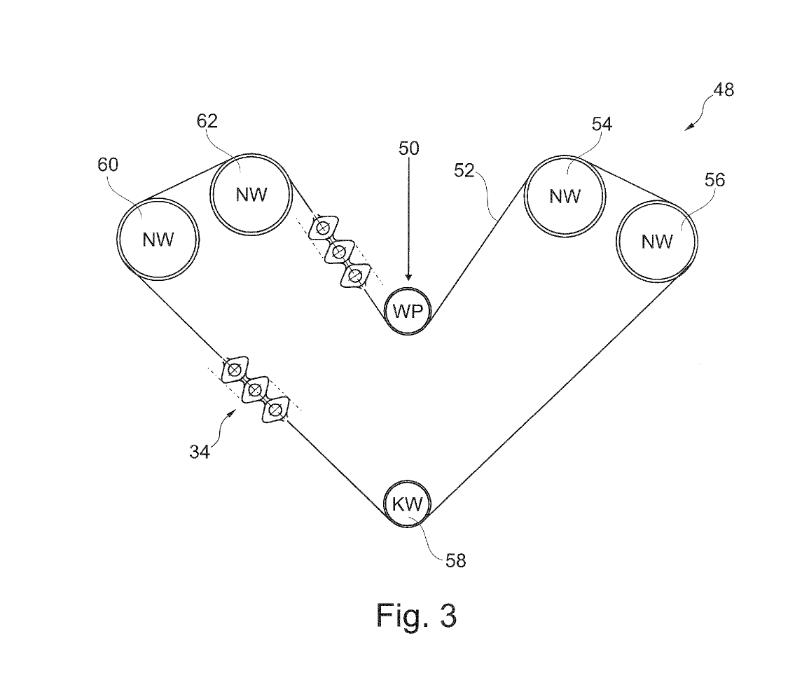

FIG. 3 shows a schematic a timing drive 48 with the toothed chain assembly 34, wherein a gear wheel of a water pump 50 is driven by the backside of the chain assembly 34. Additionally, the timing drive includes further gear wheels 54, 56, 58, 60, 62.

The present invention has been described with reference to a preferred embodiment. It should be understood that the scope of the present invention is defined by the claims and is not intended to be limited to the specific embodiment disclosed herein.

What is claimed:

1. A toothed chain, comprising:
a plurality of middle plates forming a track, each middle plate having a pair of pin holes;
a plurality of inner plates forming two tracks, each inner plate having a pair of pin holes;
a plurality of outer plates forming two tracks, each outer plate having a pair of pin holes; and
pins extending through corresponding pin holes of the outer plates, the inner plates and the middle plates to fasten the tracks of outer plates, the tracks of inner plates and the track of middle plates to each other, forming a toothed chain having an endless loop.

2. The toothed chain of claim 1, wherein the middle plates have double-sided profiles.

3. The toothed chain of claim 1, wherein the inner plates forming one of the tracks of inner plates have double-sided profiles.

4. The toothed chain of claim 1, wherein the inner plates forming both tracks of inner plates have double-sided profiles.

5. The toothed chain of claim 1, wherein the outer plates are symmetrical, such that a lower portion, projecting in a first direction, is mirrored by an upper portion, projecting in a second direction.

6. The toothed chain of claim 1, wherein tooth height of a gear wheel contacting the toothed chain is reduced to provide easier tooth entry on a backside of the toothed chain.

7. The toothed chain of claim 6, wherein the gear wheel is a component of a water pump.

8. The toothed chain of claim 7, wherein the gear wheel of the water pump is driven by a backside of the toothed chain.
